(19) United States
(12) Patent Application Publication
(10) Pub. No.: US 2026/0097582 A1
(43) Pub. Date: Apr. 9, 2026

(54) LIQUID DISCHARGE HEAD AND LIQUID DISCHARGE APPARATUS

(71) Applicants: Ryuji TSUKAMOTO, Kanagawa (JP); Naoko KITAOKA, Kanagawa (JP); Yuta KINASE, Kanagawa (JP); Masanori KUSUNOKI, Tokyo (JP)

(72) Inventors: Ryuji TSUKAMOTO, Kanagawa (JP); Naoko KITAOKA, Kanagawa (JP); Yuta KINASE, Kanagawa (JP); Masanori KUSUNOKI, Tokyo (JP)

(21) Appl. No.: 19/112,308

(22) PCT Filed: Sep. 29, 2023
(86) PCT No.: PCT/IB2023/059736

§ 371 Date: Mar. 17, 2025

(30) Foreign Application Priority Data
Oct. 25, 2022 (JP) 2022-170924

(51) Int. Cl. B41J 2/045; B41J 2/14

(52) U.S. Cl. CPC B41J 2/04525; B41J 2/04568; B41J 2/04581; B41J 2/14233; B41J 2002/14419

(57) ABSTRACT

A liquid discharge head includes a common liquid chamber having multiple liquid chambers communicating with each other through the common liquid chamber, a vibration film having multiple nozzles, multiple vibration generators, and a flexible member. The common liquid chamber stores a liquid. The multiple nozzles respectively communicate with the multiple liquid chambers. The multiple vibration generators individually vibrate the vibration film around the multiple nozzles, respectively. The flexible member is opposed to the multiple nozzles in the common liquid chamber. The flexible member is deformable by the liquid in the common liquid chamber vibrated by the vibration film.

### TECHNICAL FIELD

Embodiments of the present disclosure relate to a liquid discharge head and a liquid discharge apparatus.

### BACKGROUND ART

PTL 1 describes a recording apparatus including a cylindrical nozzle and a vibration generator. The cylindrical nozzle holds liquid ink therein and is provided with the vibration generator. The vibration generator is vibrated in a direction perpendicular to the surface of the liquid ink to generate surface tension waves in the liquid ink. The surface tension waves interfere with each other so that the wave height is maximized at the center of the surface of the liquid ink. As a result, a droplet of the liquid ink flies from the center of the surface of the liquid ink.

### CITATION LIST

### Patent Literature

### [PTL 1]

Japanese Unexamined Patent Application Publication No. H9-226111

### SUMMARY OF INVENTION

### Technical Problem

However, when the liquid ink is simultaneously discharged from multiple nozzles, the droplet velocity and the droplet amount of the liquid ink discharged from the nozzles may vary.

### Solution to Problem

A liquid discharge head according to embodiments of the present disclosure includes a common liquid chamber having multiple liquid chambers communicating with each other through the common liquid chamber, a vibration film having multiple nozzles, multiple vibration generators, and a flexible member. The common liquid chamber stores a liquid. The multiple nozzles respectively communicate with the multiple liquid chambers. The multiple vibration generators individually vibrate the vibration film around the multiple nozzles, respectively. The flexible member is opposed to the multiple nozzles in the common liquid chamber. The flexible member is deformable by the liquid in the common liquid chamber vibrated by the vibration film.

### Advantageous Effects of Invention

According to one aspect of the present disclosure, the droplet velocity and the droplet amount of the liquid simultaneously discharged from multiple nozzles are less likely to vary.

### Brief Description of Drawings

A more complete appreciation of the embodiments and many of the attendant advantages and features thereof can be readily obtained and understood from the following detailed description with reference to the accompanying drawings.

FIG. 1 is a partial cross-sectional perspective view of a nozzle vibration type liquid discharge head according to a comparative example.

FIG. 2 is an enlarged cross-sectional view of a portion X in FIG. 1.

FIG. 3 is a partial cross-sectional perspective view of a liquid discharge head according to a first embodiment of the present disclosure.

FIG. 4 is an enlarged cross-sectional view of a portion X1 of FIG. 3.

FIG. 5 is a partial cross-sectional perspective view of a liquid discharge head according to a second embodiment of the present disclosure.

FIG. 6 is an enlarged cross-sectional view of a portion X2 of FIG. 5.

FIG. 7 is a partial cross-sectional perspective view of a liquid discharge head according to a third embodiment of the present disclosure.

FIG. 8 is an enlarged cross-sectional view of a portion X3 of FIG. 7.

FIG. 9 is a partial cross-sectional perspective view of a liquid discharge head according to a fourth embodiment of the present disclosure.

FIG. 10 is an enlarged cross-sectional view of a portion X4 of FIG. 9.

FIGS. 11A to 11C are schematic views of a flexible member according to embodiments of the present disclosure.

FIGS. 12A to 12C are schematic views of another flexible member according to embodiments of the present disclosure.

FIG. 13 is a graph illustrating a comparison between the first embodiment and the comparative example.

FIG. 14 is a graph illustrating a comparison between the second embodiment and the comparative example.

FIG. 15 is a graph illustrating a comparison between the third embodiment and the comparative example.

FIG. 16 is a graph illustrating a comparison between the fourth embodiment and the comparative example.

FIG. 17 is a graph illustrating a comparison between a fifth embodiment and the comparative example.

FIG. 18 is a graph illustrating a comparison between a sixth embodiment and the comparative example.

FIG. 19 is a partial cross-sectional view of a liquid discharge head according to a modification of embodiments of the present disclosure.

FIG. 20 is a partial cross-sectional view of a liquid discharge head according to another modification of embodiments of the present disclosure.

FIG. 21 is a partial cross-sectional view of a liquid discharge head according to yet another modification of embodiments of the present disclosure.

FIG. 22 is a schematic diagram of a printer as a liquid discharge apparatus according to embodiments of the present disclosure.

FIG. 23 is a plan view of a head unit of the printer illustrated in FIG. 22.

FIG. 24 is a plan view of another printer as a liquid discharge apparatus according to embodiments of the present disclosure.

FIG. 25 is a side view of the printer illustrated in FIG. 24.

FIG. 26 is a plan view of a liquid discharge unit according to embodiments of the present disclosure.

FIG. 27 is a front view of another liquid discharge unit according to embodiments of the present disclosure.

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

### DESCRIPTION OF EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of the present disclosure are described below with reference to the drawings. In the drawings, like reference signs denote like elements, and overlapping description may be simplified or omitted as appropriate. Embodiments of the present disclosure are described below, but the present disclosure is not limited to those embodiments and any deletion, addition, modification, change, etc. can be made without departing from the scope of the present disclosure in which a person skilled in the art can conceive other embodiments, any of which is included within the scope of the present disclosure as long as the effect and feature of the present disclosure are demonstrated.

### Configuration of Nozzle Vibration Type Liquid Discharge Head

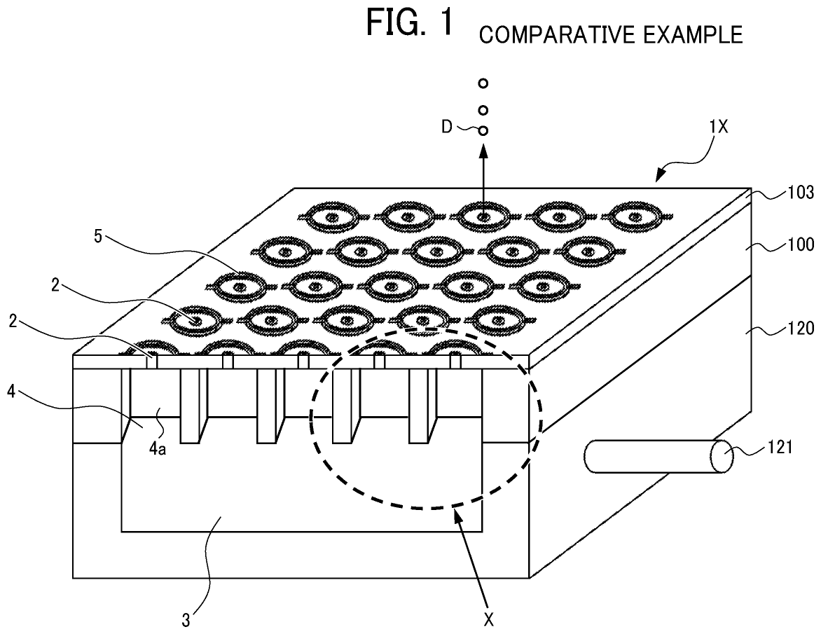

A configuration of a nozzle vibration type liquid discharge head 1X according to a comparative example is described with reference to FIG. 1. FIG. 1 is a partial cross-sectional perspective view of the nozzle vibration type liquid discharge head 1X, according to a comparative example. The liquid discharge head 1X (referred to as a head 1X in the following description) is a nozzle vibration type head having multiple nozzles 2. Each of the multiple nozzles 2 is individually vibrated to discharge a liquid in a liquid chamber 4 from the nozzle 2.

The head 1X includes a channel substrate 100, a vibration film 103, the multiple nozzles 2 from which the liquid is discharged, an annular piezoelectric element 5 disposed around each of the multiple nozzles 2, and a frame 120 supporting the channel substrate 100. The piezoelectric element 5 is an example of a vibration generator. In the channel substrate 100, the liquid chamber 4, which may be referred to as an individual liquid chamber, is opposed to the piezoelectric element 5, and the nozzle 2 communicates with the liquid chamber 4.

The frame 120 defines a common liquid chamber 3 therein. A liquid supply port 121 is disposed on the frame 120. The liquid is supplied from the liquid supply port 121 into the common liquid chamber 3, and then supplied from the common liquid chamber 3 to the multiple liquid chambers 4. A typical unimorph-type piezoelectric head, which vibrates a wall of the liquid chamber opposed to a nozzle face having the nozzles to discharge a liquid, has a closed space in the liquid chamber. By contrast, in the nozzle vibration type head 1X, the liquid chamber 4 does not have such a closed space. One liquid chamber 4 does not necessarily correspond to one nozzle 2, and may be shared by a plurality of nozzles 2.

Typically, the head 1X is used with a nozzle face (i.e., a face on which the multiple nozzles 2 are formed) facing downward in the actual normal use of a liquid discharge apparatus. In other words, the head 1X is used upside down from the posture illustrated in FIG. 1. In such a case, the liquid in the common liquid chamber 3 flows so as to spread over the liquid chambers 4, and the liquid flowing into the liquid chambers 4 is held in the liquid chambers 4 by internal walls 4a of the liquid chambers 4. The internal wall 4a is an example of a partition. The shape of the internal wall 4a of the liquid chamber 4 is not limited to a flat face as illustrated in the drawings. For example, a curved internal wall 4a may define the liquid chamber 4 having a cylindrical shape. In the above description, the common liquid chamber 3 and the liquid chamber 4 are distinguished from each other for convenience in describing how the liquid is supplied. In other words, the liquid chamber 4 can be regarded as a part of the common liquid chamber 3.

In the head 1X having the above-described configuration, the piezoelectric element 5 vibrates the periphery of the nozzle 2 to discharge the liquid in the liquid chamber 4 from the nozzle 2 as a droplet D. Such a nozzle vibration type head can discharge the droplet D of the liquid with a smaller power than a unimorph-type piezoelectric head. Thus, power saving can be achieved.

The increased density of the nozzles 2 limits a space for laying out wiring for voltage application. In such a case, it is difficult to install the wiring on the surface of substrate (e.g., the channel substrate 100). However, the wiring and a drive circuit can be installed in the substrate having the nozzles 2 with high density. Lead zirconate titanate (PZT) is common in a typical material of a piezoelectric element because of good piezoelectric properties, but the film formation and crystallization temperature of PZT is 600° C. or higher. When PZT is used as the material of the piezoelectric element, the drive circuit and the wiring in the substrate do not withstand the high temperature. In such a case, a piezoelectric material having the film formation temperature lower than that of PZT can be used. Such a piezoelectric material has poor piezoelectric properties than PZT.

However, as described above, since the nozzle vibration type head can discharge droplets of the liquid with the smaller power than the typical unimorph-type piezoelectric head, even when the piezoelectric material having the poorer piezoelectric properties than PZT is used, the nozzle vibration type head can discharge droplets of the liquid as desired. Accordingly, the nozzle vibration type head using the piezoelectric material such as a non-lead material, which has a low film formation and crystallization temperature but has the poor piezoelectric properties, can discharge droplets of the liquid as desired. As a result, the wiring and the drive circuit can be installed in the substrate, and the nozzles 2 can arranged with high density. Further, the nozzle vibration type head can reduce the volume of the liquid chamber 4. As a result, the head can be downsized.

Although the multiple nozzles 2 and the respective piezoelectric elements 5 are two dimensionally arranged in rows and columns in FIG. 1, the arrangement of the nozzles 2 and the piezoelectric elements 5 is not limited thereto. For example, the head may include the nozzles 2 and the piezoelectric elements 5 arrayed in a line.

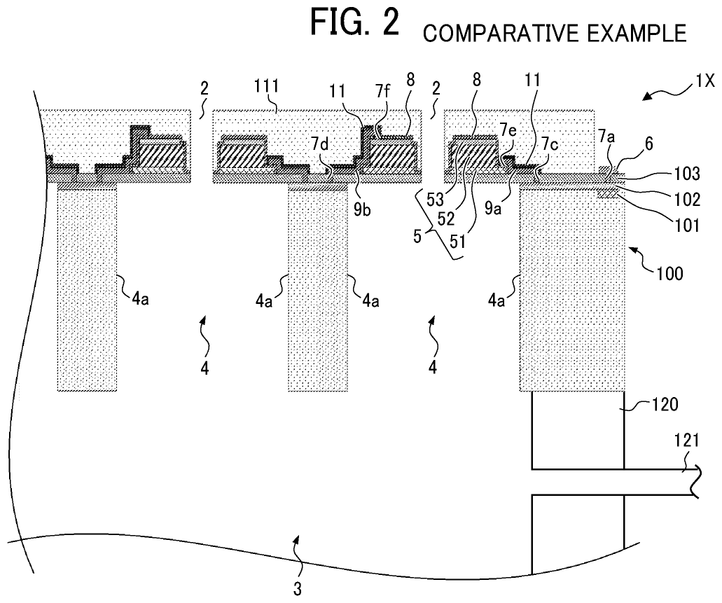

A portion X in FIG. 1 is described below in detail. FIG. 2 is an enlarged cross-sectional view of the portion X in FIG. 1.

The channel substrate 100 is a silicon on insulator (SOI) substrate. The channel substrate 100 includes a drive circuit 101 and a wiring 102 on a side on which a vibration film 103 is formed. The drive circuit 101 includes, for example, a transistor and a resistor. The wiring 102 includes a wiring for applying a voltage to a first electrode 51 and a wiring for applying a voltage to a second electrode 53.

The wiring 102 is electrically connected to an electrical connection pad 6 through a hole-shaped first contact 7a disposed at one end of the vibration film 103 (the right end in FIG. 2). The vibration film 103 also has a hole-shaped second contact at the other end (the left end omitted in FIG. 2), and the wiring 102 is electrically connected to the electrical connection pad 6, which is disposed at the other end, through the second contact.

The head 1X includes the multiple nozzles 2 and a nozzle forming portion (film) 111 that covers the piezoelectric element 5. The nozzle forming portion 111 is omitted in FIG. 1 for simplicity. The nozzle forming portion 111 may have a liquid-repellent film (water-repellent film) on the surface of the nozzle face on which the nozzles 2 are arranged. The liquid-repellent film on the nozzle face prevents liquid from adhering to the nozzle face. Due to such a configuration, liquid can be discharged from the nozzles 2 without being affected by the liquid adhering to the nozzle face. When the solvent of the liquid is aqueous, perfluorodecyltrichlorosilane or perfluorooctyltrichlorosilane can be used as the material of the liquid-repellent film.

The piezoelectric element 5 includes the first electrode 51, a piezoelectric film 52, and the second electrode 53. The first electrode 51 may be referred to as a lower electrode, and the second electrode 53 may be referred to as an upper electrode. The piezoelectric element 5 is laminated over the vibration film 103. The piezoelectric element 5 and the liquid chamber 4 are disposed on the opposite sides of the vibration film 103. The piezoelectric element 5 is covered with an insulating film 8. The insulating film 8 has a hole-shaped fifth contact 7e through which the first electrode 51 and a first lead 9a are electrically connected, and a hole-shaped sixth contact 7f through which the second electrode 53 and a second lead 9b are electrically connected. The first lead 9a is disposed on the insulating film 8 to electrically connect the first electrode 51 and the wiring 102 of the channel substrate 100. The second lead 9b is disposed on the insulating film 8 to electrically connect the second electrode 53 and the wiring 102.

One end of the first lead 9a is electrically connected to the first electrodes 51 through the fifth contact 7e of the insulating film 8, and the other end of the first lead 9a is electrically connected to the wiring 102 through a third contact 7c of the vibration film 103. One end of the second lead 9b is electrically connected to the second electrode 53 through the sixth contact 7f of the insulating film 8, and the other end of the second lead 9b is electrically connected to the wiring 102 through a fourth contact 7d of the vibration film 103.

The first lead 9a and the second lead 9b are covered with a moisture-proof film 11. Due to such a configuration, moisture may permeate through the nozzle forming portion 111 made of resin but does not reach the first lead 9a and the second lead 9b. As a result, corrosion of the first lead 9a and the second lead 9b can be prevented.

The moisture-proof film 11 is preferably made of a material having an electrical insulation property. For example, silicon nitride (SiN), which is common in a moisture-proof film for a semiconductor, is preferable so that the moisture-proof film 11 can have two functions of the electrical insulation and moisture-proof properties. In addition to SiN, examples of the material of the moisture-proof film 11 include oxides of aluminum (Al), tantalum (Ta), niobium (Nb), titanium (Ti), hafnium (Hf), zirconium (Zr), and tungsten (W), which can be easily formed in a dense film by atomic layer deposition (ALD). Since the moisture-proof film 11 has two functions of the electrical insulation and moisture-proof properties, the thickness of the moisture-proof film 11 can be reduced as compared with the total thickness of the moisture-proof film 11 and an insulating film separately formed under the moisture-proof film 11. Such a configuration facilitates deformation of the vibration film 103, and enhances vibration efficiency.

The first electrode 51 and the second electrode 53 of the piezoelectric element 5 are made of a metal having high corrosion resistance such as iridium (Ir) or molybdenum (Mo). As a result, the first electrode 51 and the second electrode 53 are hardly corroded by moisture permeating through the nozzle forming portion 111.

The frame 120 is bonded to the back side (lower side in FIG. 2) of the channel substrate 100 to define the common liquid chamber 3 communicating with the multiple liquid chambers 4.

In the above-described configuration, in the head 1X, as a predetermined drive waveform (voltage) is applied to the first electrode 51 and the second electrode 53 of the piezoelectric element 5, the piezoelectric film 52 vibrates, and the vibration film 103 vibrates in the vertical direction in FIG. 2. As the vibration film 103 vibrates, the pressure of the liquid in the liquid chamber 4 is changed, and the liquid is discharged from the nozzle 2.

When multiple nozzles 2 are simultaneously driven in the nozzle vibration type head 1X, fluid crosstalk may adversely affect a discharge state between adjacent nozzles 2. The nozzles may be referred to as channels in the following description. In the fluid crosstalk, the pressure generated by the vibrations of the piezoelectric element 5 propagates to the adjacent liquid chamber 4 through the liquid to change the discharge state (e.g., a droplet velocity and a droplet amount of the liquid discharged from the nozzles 2). As the number of nozzles (channels) to be simultaneously driven increases, the fluid crosstalk through the liquid increases, and variations in the discharge state among the channels become remarkable. As a result, the liquid may not be uniformly and accurately applied to a target.

For this reason, in the embodiments of the present disclosure described below, a component that absorbs the vibrations of the liquid is disposed inside the common liquid chamber 3 to reduce the fluid crosstalk. Embodiments of the present disclosure are described below.

### First Embodiment

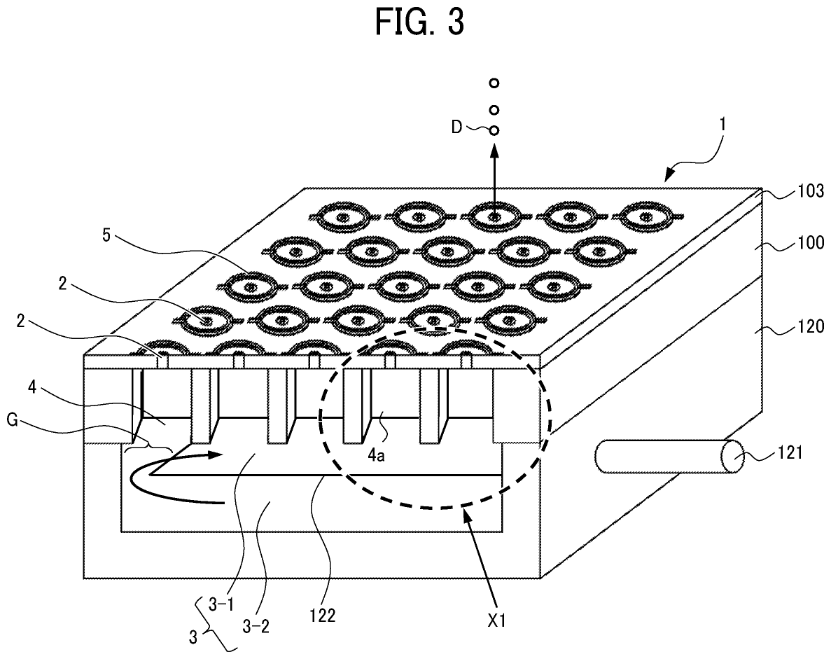

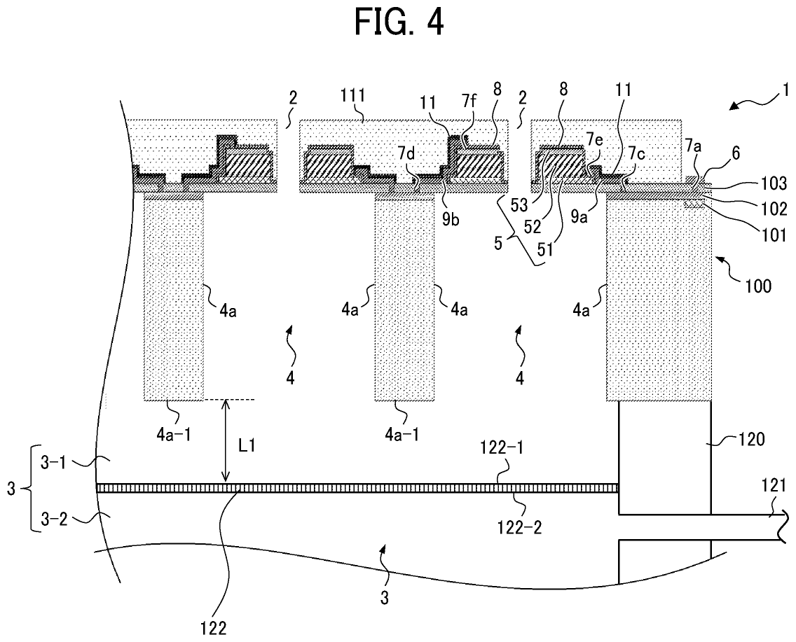

A first embodiment of the present disclosure is described below with reference to FIGS. 3 and 4. FIG. 3 is a partial cross-sectional perspective view of a liquid discharge head 1 (referred to as a head 1 in the following description) according to the first embodiment of the present disclosure. FIG. 4 is an enlarged cross-sectional view of a portion X1 in FIG. 3. Like reference signs denote like elements that have already been described, and redundant description is omitted.

In the first embodiment, an elastic film 122, which is an example of a flexible member, is disposed in the common liquid chamber 3. The common liquid chamber 3 is divided into a common liquid chamber 3-1 and a common liquid chamber 3-2 by the elastic film 122. In the common liquid chamber 3, one side of the elastic film 122 facing the nozzles 2 is defined as a first face 122-1, and the other side opposite to the first face 122-1 is defined as a second face 122-2. In the above definition, according to the first embodiment, both the first face 122-1 and the second face 122-2 (i.e., film faces) of the elastic film 122 are in contact with the liquid in the common liquid chamber 3. In other words, the elastic film 122 is disposed in the liquid. The film faces of the elastic film 122 are not necessarily parallel to the nozzle face. If the head 1 can reduce variations in the droplet velocity and the droplet amount of the liquid discharged from the nozzles 2, the film faces may be inclined with respect to the nozzle face.

The elastic film 122 is secured to the frame 120 at a position above the liquid supply port 121 on the frame 120 in FIG. 4. In other words, the elastic film 122 is disposed between the liquid chamber 4 and the liquid supply port 121 in the common liquid chamber 3. The elastic film 122 does not have openings such as through holes on the film faces. If the elastic film 122 has the same area as that of the common liquid chamber 3, the interior of the common liquid chamber 3 is isolatedly divided into an upper portion and a lower portion by the elastic film 122 as a boundary, and the liquid supplied from the liquid supply port 121 to the common liquid chamber 3 is not fed to the liquid chamber 4. Accordingly, in the first embodiment, a gap G is disposed between the elastic film 122 and the frame 120 on the left side in FIG. 3 in the present embodiment, and the liquid in the common liquid chamber 3 can be fed to the liquid chamber 4 through the gap G.

The material of the elastic film 122 is not limited to any particular material and can be any material that is deformed in response to the vibrations generated in the common liquid chamber 3. Examples of the material include plastic materials such as polyimide, polypropylene, polyethylene, and nylon, and metal materials such as steel use stainless (SUS), titanium, and nickel.

The first face 122-1 of the elastic film 122 is disposed away from an end 4a-1 of the internal wall 4a of the liquid chamber 4 by a predetermined distance L1. The end 4a-1 is an example of a first end of the partition.

The distance L1 is preferably in a range of 10 to 600 μm. When the distance L1 is smaller than 10 μm, the liquid may not be satisfactorily fed from the common liquid chamber 3 to the liquid chambers 4. When the distance L1 is larger than 600 μm, the elastic film 122 may not absorb the vibrations of the liquid as desired, and thus the fluid crosstalk is not sufficiently reduced.

The elastic film 122 is not limited to one sheet. For example, the interior of the common liquid chamber 3 may be divided into multiple regions, and multiple elastic films may be provided for the multiple regions in accordance with the effect for the respective regions. Multiple elastic films may be provided in multiple stages. For example, two elastic films are opposed to each other in two stages.

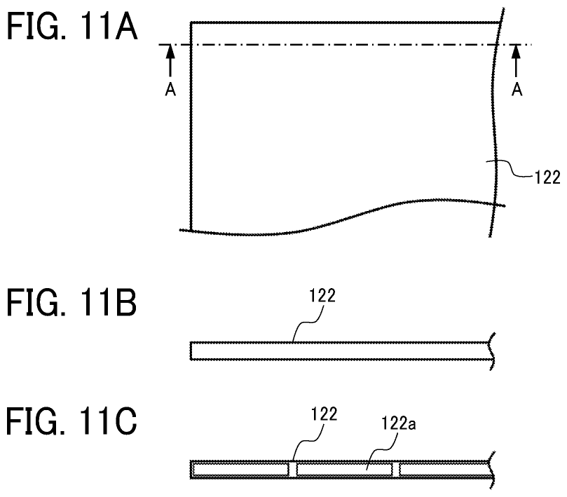

The structure of the elastic film 122 used in the first embodiment is described in more detail with reference to FIGS. 11A to 11C. FIGS. 11A to 11C are schematic views of the flexible member. FIG. 11A is a partial plan view of the flexible member, and FIGS. 11B and 11C are cross-sectional views of the flexible member taken along line A-A in FIG. 11A.

The flexible member illustrated in FIG. 11B and the flexible member illustrated in FIG. 11C are similar in appearance in plan view but different in cross-sectional structure. The elastic film 122, which is an example of the flexible member, illustrated in the cross-sectional view of FIG. 11B is made of a solid material. On the other hand, the elastic film 122 illustrated in the cross-sectional view of FIG. 11C is made of a hollow material having a hollow portion 122a. Air is enclosed in the hollow portion 122a to form an air layer.

In the first embodiment, the elastic film 122 illustrated in FIG. 11B or 11C can be used. The elastic film 122 having the air layer illustrated in FIG. 11C can attenuate the vibrations of the liquid more effectively.

As described above, the head 1 according to the present embodiment includes the common liquid chamber 3 to store a liquid, the multiple nozzles 2 communicating with the common liquid chamber 3, the piezoelectric elements 5 to individually vibrate the multiple nozzles 2, and the elastic film 122 in the common liquid chamber 3 to reduce vibrations of the liquid. The common liquid chamber 3 includes the liquid chambers 4 corresponding to the multiple nozzles 2, and the elastic film 122 is disposed at a position facing the multiple nozzles 2 of the liquid chambers 4.

In addition, as described above, the elastic film 122 in the common liquid chamber 3 has the first face 122-1 opposed to the multiple nozzles 2 and the second face 122-2 opposite the first face 122-1. The first face 122-1 and the second face 122-2 of the elastic film 122 are in contact with the liquid in the common liquid chamber 3.

As described above, examples of the elastic film 122 include a resin film.

Further, as described above, examples of the elastic film 122 include a metal film.

As the multiple piezoelectric elements 5 are simultaneously driven, the liquid in the liquid chamber 4 is vibrated, and the vibrations of the liquid are absorbed (attenuated) by the elastic film 122. Accordingly, the vibrations are less likely to propagate to the adjacent liquid chamber 4. Thus, the variations in the discharge state among the channels caused by the fluid crosstalk can be reduced. As a result, the liquid can be uniformly and accurately applied to the target.

As described above, the elastic film 122 has the air layer (the hollow portion 122a in which air is enclosed) between the first face 122-1 and the second face 122-2.

As described above, the head 1 further includes the internal wall 4a on the side facing the first face 122-1 of the elastic film 122 to partition adjacent nozzles 2 of the multiple nozzles 2. When an end of the internal wall 4a close to the first face 122-1 of the elastic film 122 is defined as a first end 4a-1, the distance L1 between the first face 122-1 of the elastic film 122 and the first end 4a-1 of the internal wall 4a is in the range of 10 to 600 μm.

Accordingly, the vibrations of the liquid can be more effectively absorbed (attenuated).

### Second Embodiment

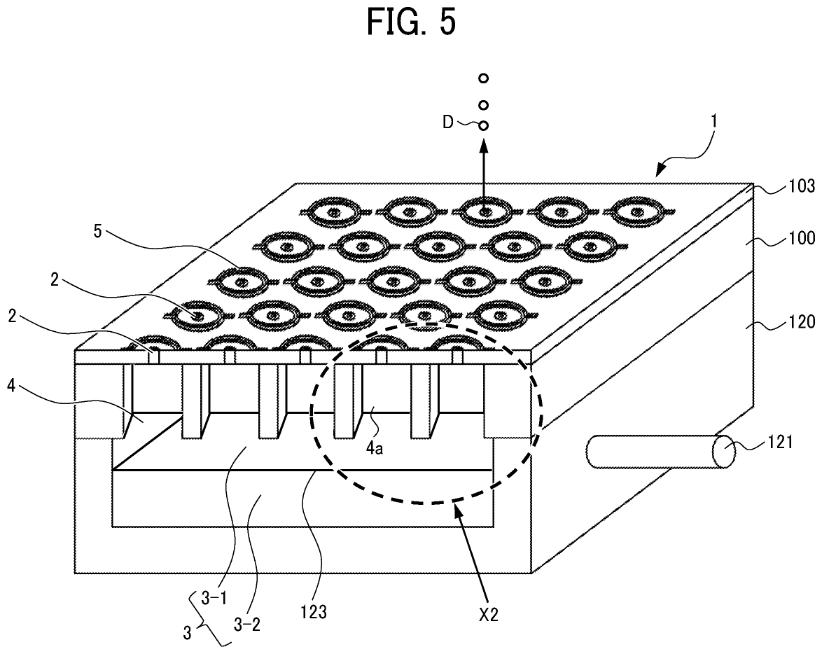

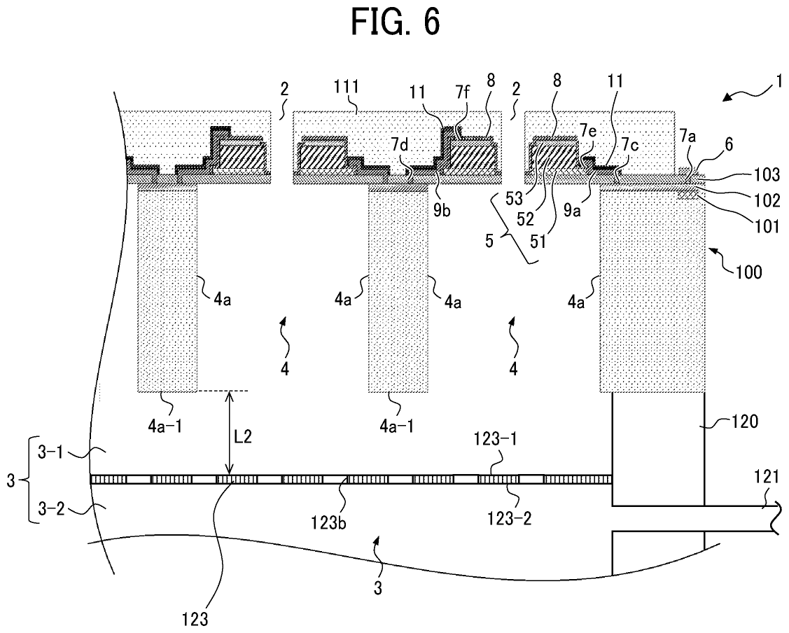

A second embodiment of the present disclosure is described below with reference to FIGS. 5 and 6. FIG. 5 is a partial cross-sectional perspective view of a liquid discharge head 1 according to the second embodiment. FIG. 6 is an enlarged cross-sectional view of a portion X2 in FIG. 5. Like reference signs denote like elements that have already been described, and redundant description is omitted.

In the second embodiment, an elastic film 123, which is an example of the flexible member, is disposed in the common liquid chamber 3. In the common liquid chamber 3, one side of the elastic film 123 facing the nozzles 2 is defined as a first face 123-1, and the other side opposite to the first face 123-1 is defined as a second face 123-2. In the above definition, according to the second embodiment, both the first face 123-1 and the second face 123-2 (i.e., film faces) of the elastic film 123 are in contact with the liquid in the common liquid chamber 3. In other words, the elastic film 123 is disposed in the liquid.

The elastic film 123 is secured to the frame 120 at a position above the liquid supply port 121 on the frame 120 in FIG. 6. As illustrated in FIG. 6, multiple openings 123b penetrating the first face 123-1 and the second face 123-2 are formed in the elastic film 123. The size of the opening 123b is not particularly limited, but in the present embodiment, the opening 123b is a circular hole having a diameter on the order of several tens of micrometers. In the second embodiment, the liquid in the common liquid chamber 3 can be fed into the liquid chambers 4 through the openings 123b without the gap G, which is formed in the first embodiment.

Accordingly, the elastic film 123 can have the same area as the area of the common liquid chamber 3.

The material of the elastic film 123 is not limited to any particular material and can be any material that is deformed in response to the vibrations generated in the common liquid chamber 3. Examples of the material include plastic materials such as polyimide, polypropylene, polyethylene, and nylon, and metal materials such as SUS, titanium, and nickel.

The first face 123-1 of the elastic film 123 is disposed away from the end 4a-1 of the internal wall 4a of the liquid chamber 4 by a predetermined distance L2. The end 4a-1 is an example of the first end of the partition.

The distance L2 is preferably in a range of 10 to 600 μm. In the present embodiment, the distance L2 is 100 μm. When the distance L2 is smaller than 10 μm, the liquid may not be satisfactorily fed from the common liquid chamber 3 to the liquid chambers 4. When the distance L2 is larger than 600 μm, the elastic film 123 may not absorb the vibrations of the liquid as desired, and thus the fluid crosstalk is not sufficiently reduced.

The elastic film 123 is not limited to one sheet. For example, the interior of the common liquid chamber 3 may be divided into multiple regions, and multiple elastic films may be provided for the multiple regions in accordance with the effect for the respective regions.

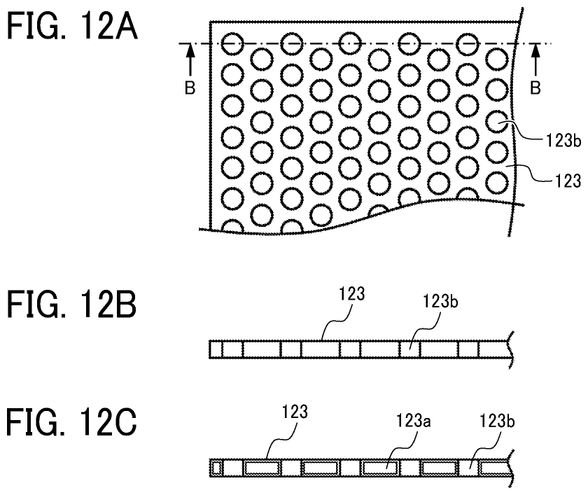

The structure of the elastic film 123 used in the second embodiment is described in more detail with reference to FIGS. 12A to 12C. FIGS. 12A to 12C are schematic views of the flexible member. FIG. 12A is a partial plan view of the flexible member, and FIGS. 12B and 12C are cross-sectional views of the flexible member taken along line B-B in FIG. 12A.

The flexible member illustrated in FIG. 12B and the flexible member illustrated in FIG. 12C are similar in appearance in plan view but different in cross-sectional structure. The elastic film 123, which is an example of the flexible member, illustrated in the cross-sectional view of FIG. 12B is made of a solid material except for the openings 123b. On the other hand, the elastic film 123 illustrated in the cross-sectional view of FIG. 12C is made of a hollow material having a hollow portion 123a except for the openings 123b. Air is enclosed in the hollow portion 123a to form the air layer.

For example, the elastic film 123 is a polyimide film having a thickness of 100 μm, and the openings 123b having the diameter on the order of several tens of micrometers are formed in the elastic film 123 at an aperture ratio of 75%. The size, shape, and arrangement of the openings 123b formed in the elastic film 123 can be appropriately changed, for example, in accordance with the discharge state of the liquid. Further, the size and shape of the openings 123b formed in the elastic film 123 are not limited to one type. For example, two or more types of openings 123b having different sizes and shapes may be mixed in one elastic film 123

In the second embodiment, the elastic film 123 illustrated in FIG. 12B or 12C can be used. The elastic film 123 having the air layer illustrated in FIG. 12C (i.e., a fifth embodiment) can attenuate the vibrations of the liquid more effectively.

As described above, the head 1 according to the present embodiment includes the common liquid chamber 3 to store a liquid, the multiple nozzles 2 communicating with the common liquid chamber 3, the piezoelectric elements 5 to individually vibrate the multiple nozzles 2, and the elastic film 123 in the common liquid chamber 3 to reduce vibrations of the liquid. The common liquid chamber 3 includes the liquid chambers 4 corresponding to the multiple nozzles 2, and the elastic film 123 is disposed at a position facing the multiple nozzles 2 of the liquid chambers 4.

In addition, as described above, the elastic film 123 in the common liquid chamber 3 has the first face 123-1 opposed to the multiple nozzles 2 and the second face 123-2 opposite the first face 123-1. The first face 123-1 and the second face 123-2 of the elastic film 123 are in contact with the liquid in the common liquid chamber 3.

As described above, examples of the elastic film 123 include a resin film.

Further, as described above, examples of the elastic film 123 include a metal film.

As the multiple piezoelectric elements 5 are simultaneously driven, the liquid in the liquid chamber 4 is vibrated, and the vibrations of the liquid are absorbed (attenuated) by the elastic film 123. Accordingly, the vibrations are less likely to propagate to the adjacent liquid chamber 4. Thus, the variations in the discharge state among the channels caused by the fluid crosstalk can be reduced. As a result, the liquid can be uniformly and accurately applied to the target.

As described above, the elastic film 123 has the multiple openings 123b penetrating the first face 123-1 and the second face 123-2 (i.e., penetrating through the elastic film 123).

As described above, the elastic film 123 includes the air layer (the hollow portion 123a in which air is enclosed) between the first face 123-1 and the second face 123-2.

As described above, the head 1 further includes the internal wall 4a on the side facing the first face 123-1 of the elastic film 123 to partition adjacent nozzles 2 of the multiple nozzles 2. When an end of the internal wall 4a close to the first face 123-1 of the elastic film 123 is defined as the first end 4a-1, the distance L2 between the first face 123-1 of the elastic film 123 and the first end 4a-1 of the internal wall 4a is in the range of 10 to 600 μm.

### Accordingly, the Vibrations of the Liquid Can Be More Effectively Absorbed (attenuated).

### Third Embodiment

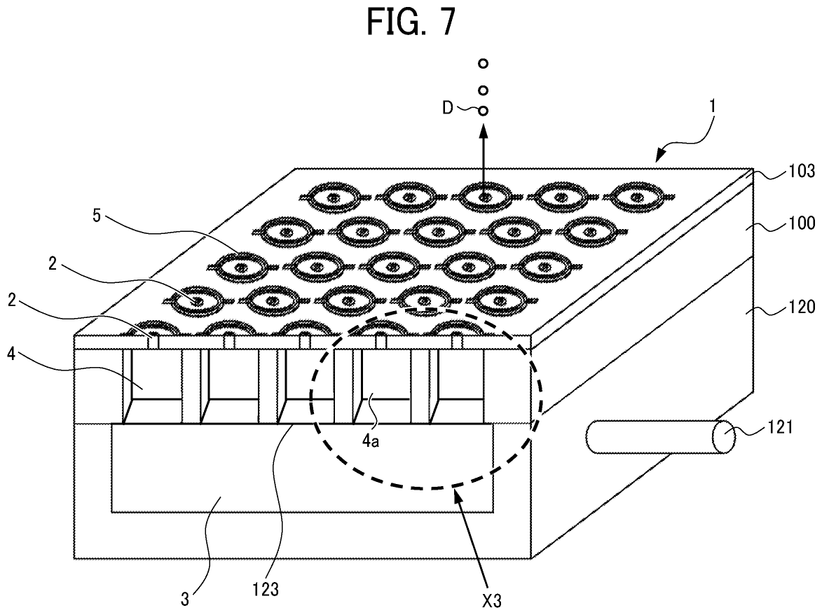

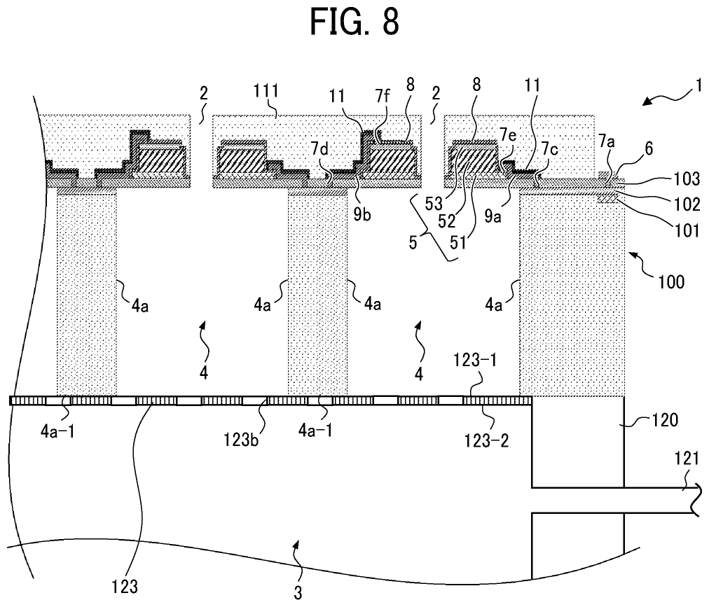

A third embodiment of the present disclosure is described below with reference to FIGS. 7 and 8. FIG. 7 is a partial cross-sectional perspective view of a liquid discharge head 1 according to the third embodiment. FIG. 8 is an enlarged cross-sectional view of a portion X3 in FIG. 7. Like reference signs denote like elements that have already been described, and redundant description is omitted.

The third embodiment is different from the above-described second embodiment in the installation position of the elastic film 123. The elastic film 123 may be installed such that the first face 123-1 of the elastic film 123 is in contact with the first end 4a-1 of the internal wall 4a defining the liquid chamber 4.

Also in the third embodiment, the elastic film 123 illustrated in FIG. 12B or 12C can be used. The elastic film 123 having the air layer illustrated in FIG. 12C can attenuate the vibrations of the liquid more effectively.

As described above, the head 1 according to the present embodiment further includes the internal wall 4a on the side facing the first face 123-1 of the elastic film 123 to partition adjacent nozzles 2 of the multiple nozzles 2. When an end of the internal wall 4a close to the first face 123-1 of the elastic film 123 is defined as the first end 4a-1, the first face 123-1 of the elastic film 123 is in contact with the first end 4a-1 of the internal wall 4a.

As the multiple piezoelectric elements 5 are simultaneously driven, the liquid in the liquid chamber 4 is vibrated, and the vibrations of the liquid are absorbed (attenuated) by the elastic film 123. Accordingly, the vibrations are less likely to propagate to the adjacent liquid chamber 4. Thus, the variations in the discharge state among the channels caused by the fluid crosstalk can be reduced. As a result, the liquid can be uniformly and accurately applied to the target.

### Fourth Embodiment

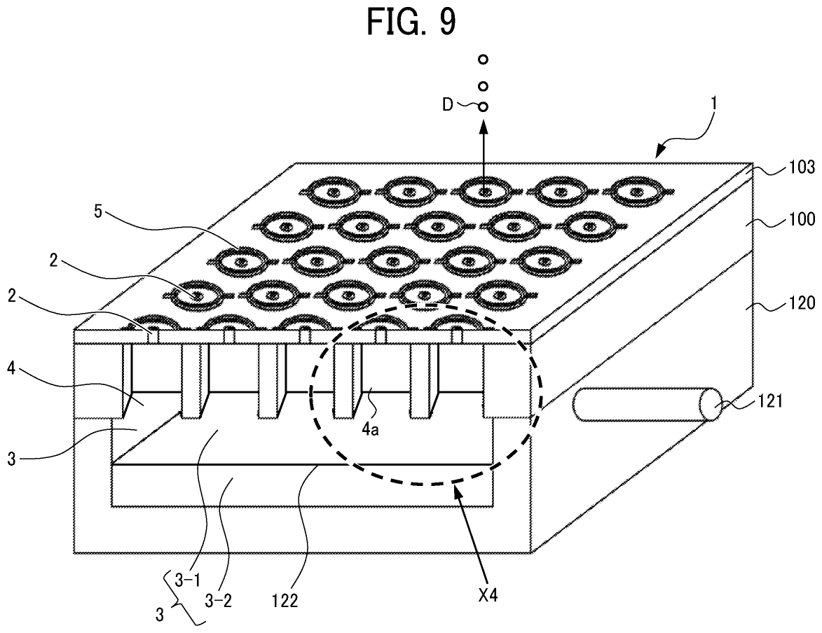

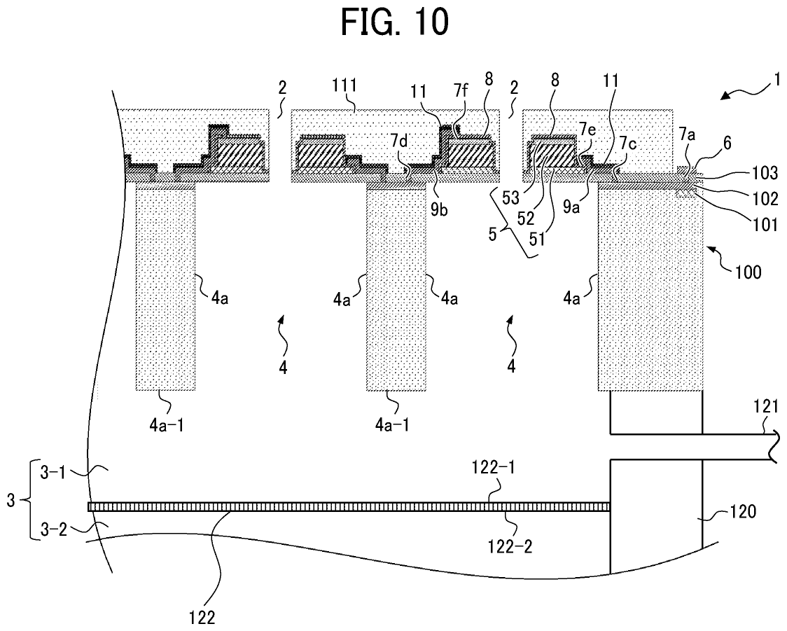

A fourth embodiment of the present disclosure is described below with reference to FIGS. 9 and 10. FIG. 9 is a partial cross-sectional perspective view of a liquid discharge head 1 according to the fourth embodiment. FIG. 10 is an enlarged cross-sectional view of a portion X4 in FIG. 9. Like reference signs denote like elements that have already been described, and redundant description is omitted.

The fourth embodiment is different from the above-described first embodiment in how the elastic film 122 is in contact with the liquid. The elastic film 122 may be installed such that only the first face 122-1 is in contact with the liquid in the common liquid chamber 3 and the second face 122-2 is in contact with air in the common liquid chamber 3. In this case, the elastic film 122 is secured to the frame 120 at a position below the liquid supply port 121 on the frame 120 in FIG. 10, and the liquid is supplied to a portion of the common liquid chamber 3 facing the first face 122-1 of the elastic film 122. The second face 122-2 of the elastic film 122 may be in contact with any gas, which can appropriately maintain a pressure in the common liquid chamber 3, other than the air.

With the above-described configuration, the gap G through which the liquid is fed from the second face 122-2 side to the first face 122-1 side of the elastic film 122 is unnecessary, and the elastic film 122 can be installed with the same area as the area of the common liquid chamber 3. In addition, since the second face 122-2 of the elastic film 122 is in contact with the air, the elastic film 122 having a simple configuration can achieve an effect equivalent to that of the elastic film 122 having the hollow portion 122a filled with air.

Also in the fourth embodiment, the elastic film 122 illustrated in FIG. 11B or 11C can be used. The elastic film 122 having the air layer illustrated in FIG. 11C (i.e., a sixth embodiment) can attenuate the vibrations of the liquid more effectively.

As described above, in the present embodiment, the first face 122-1 of the elastic film 122 is in contact with the liquid in the common liquid chamber 3 and the second face 122-2 of the elastic film 122 is in contact with gas in the common liquid chamber 3.

As the multiple piezoelectric elements 5 are simultaneously driven, the liquid in the liquid chamber 4 is vibrated, and the vibrations of the liquid are absorbed (attenuated) by the elastic film 122. Accordingly, the vibrations are less likely to propagate to the adjacent liquid chamber 4. Thus, the variations in the discharge state among the channels caused by the fluid crosstalk can be reduced. As a result, the liquid can be uniformly and accurately applied to the target.

### Comparison Between Embodiments and Comparative Example

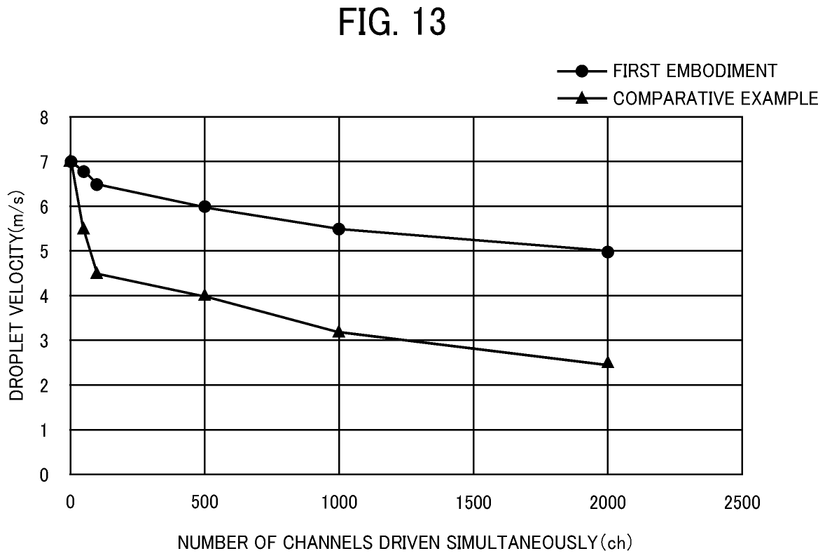

FIGS. 13 to 18 each illustrate a comparison result between each of the first to sixth embodiments and the comparative example. The comparison result represents a change in the speed of the droplet discharged from the nozzles 2 (i.e., the droplet velocity) when the number of the piezoelectric elements 5 corresponding to the nozzles 2 (i.e., the number of channels), which are driven simultaneously, is increased. The liquid discharge head 1X according to the comparative example does not have the flexible member (i.e., the elastic film 122 or 123) in the common liquid chamber 3.

FIG. 13 illustrates a result of comparison between the first embodiment and the comparative example. In the first embodiment described with reference to FIGS. 3 and 4, the elastic film 122 made of the solid material illustrated in the cross-sectional view of FIG. 11B is used.

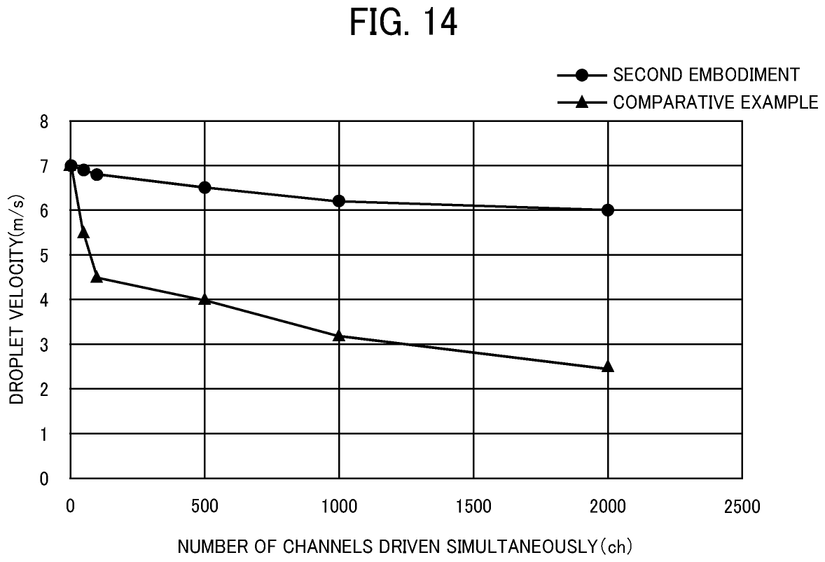

FIG. 14 illustrates a result of comparison between the second embodiment and the comparative example. In the second embodiment described with reference to FIGS. 5 and 6, the elastic film 123 made of the solid material except for the openings 123b illustrated in the cross-sectional view of FIG. 12B is used.

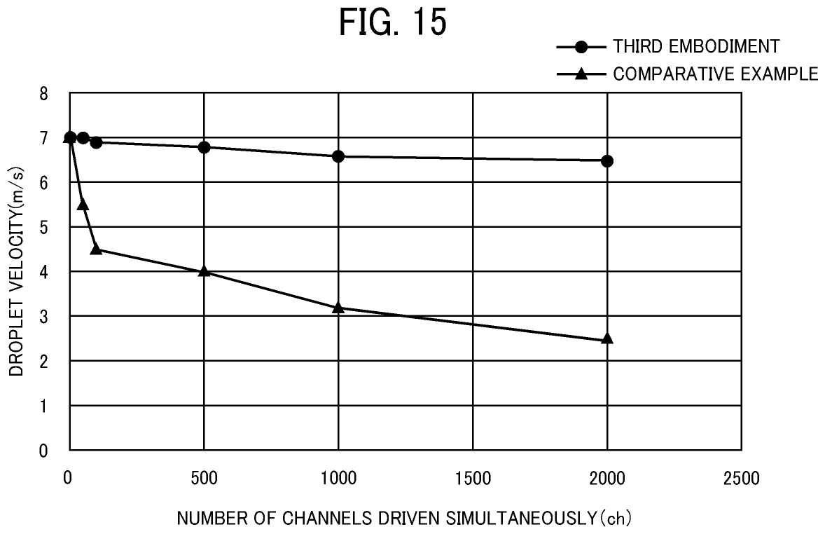

FIG. 15 illustrates a result of comparison between the third embodiment and the comparative example. In the third embodiment described with reference to FIGS. 7 and 8, the elastic film 123 made of the solid material except for the openings 123b illustrated in the cross-sectional view of FIG. 12B is used.

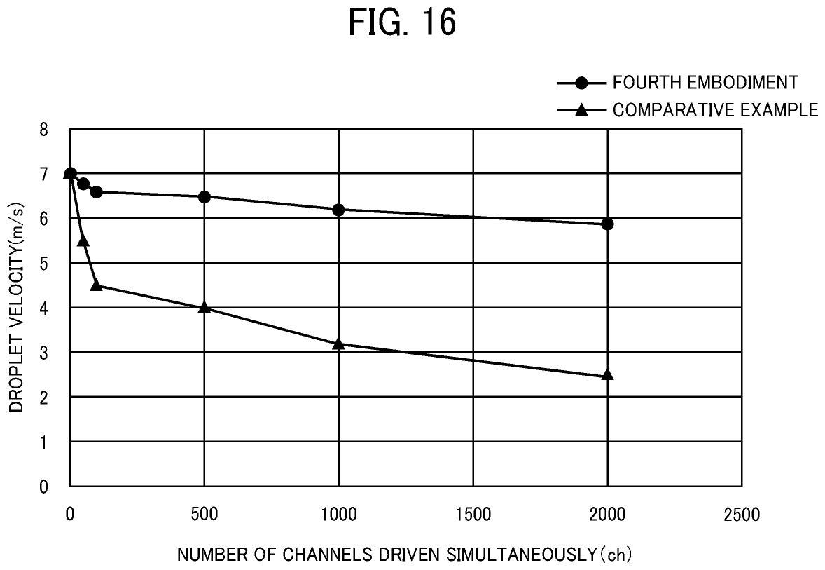

FIG. 16 illustrates a result of comparison between the fourth embodiment and the comparative example. In the fourth embodiment described with reference to FIGS. 9 and 10, the elastic film 122 made of the solid material illustrated in the cross-sectional view of FIG. 11B is used.

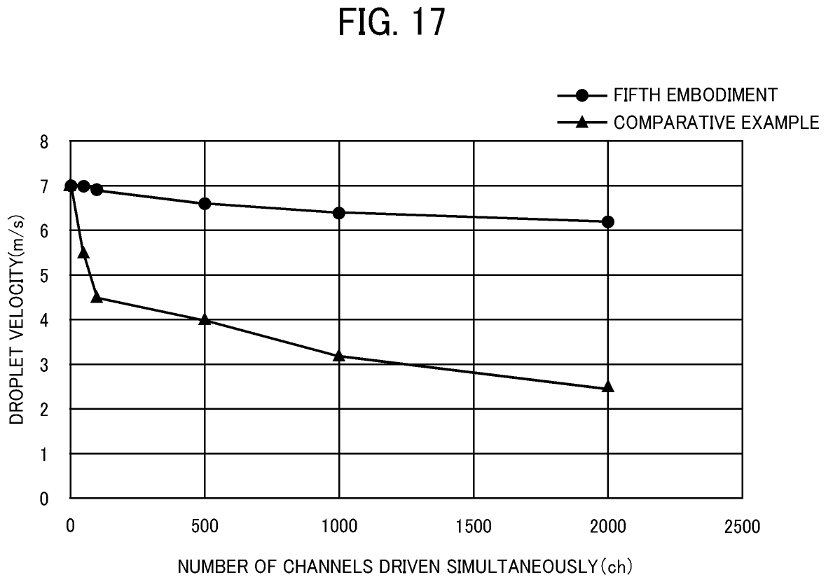

FIG. 17 illustrates a result of comparison between the fifth embodiment and the comparative example. In the fifth embodiment described with reference to FIGS. 5 and 6, the elastic film 123 made of the hollow material except for the openings 123b illustrated in the cross-sectional view of FIG. 12C is used.

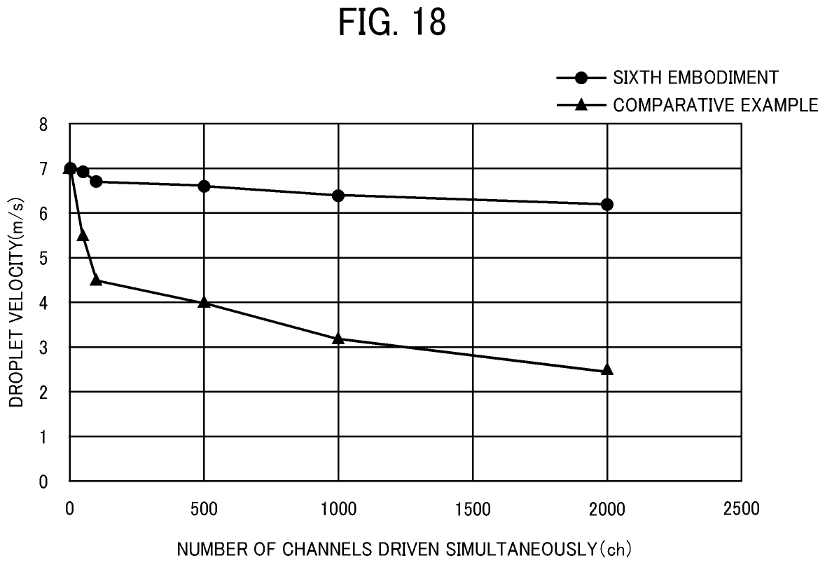

FIG. 18 illustrates a result of comparison between the sixth embodiment and the comparative example. In the sixth embodiment described with reference to FIGS. 9 and 10, the elastic film 122 made of the hollow material illustrated in the cross-sectional view of FIG. 11C is used.

In any of the first to sixth embodiments, the elastic film 122 or 123 absorbs the vibrations generated in the liquid chamber 4, and thus the vibrations are less likely to propagate to the adjacent liquid chamber 4. As a result, the decrease in the droplet velocity due to the increase in the number of channels driven simultaneously is greatly reduced as compared with the comparative example.

### Modification

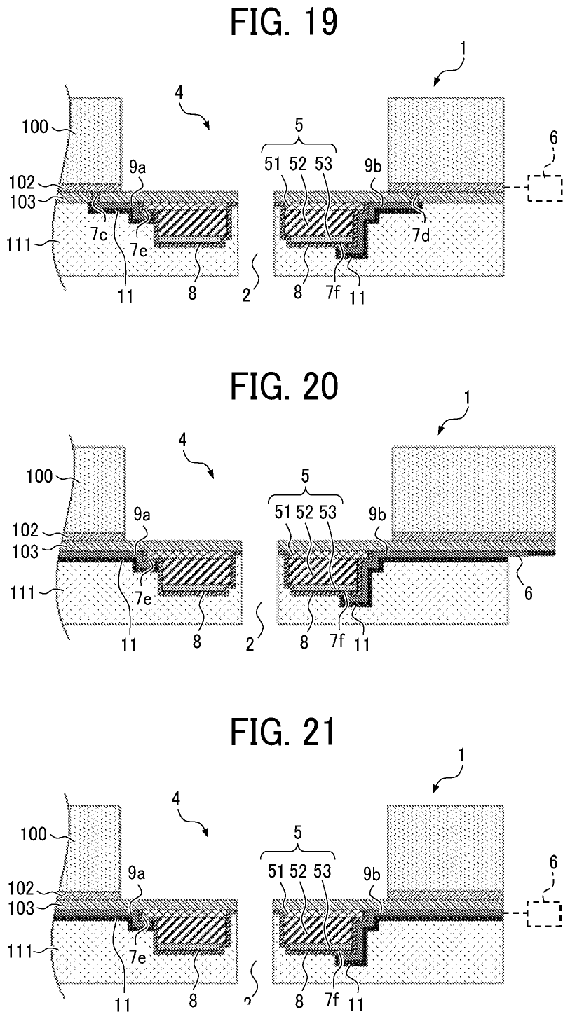

A liquid discharge head 1 according to modifications of the above-described embodiments of the present disclosure is described below. FIGS. 19 to 21 are partial cross-sectional views of the liquid discharge head 1 according to the modifications of the above-described embodiments of the present disclosure. In FIGS. 19 to 21, the head 1 is illustrated upside down as compared with the head 1 (or 1X) illustrated in FIGS. 1 to 10. In FIGS. 19 to 21, an illustration of the frame 120 is omitted.

The electrical connection pad 6 can have various configurations in the head 1. For example, as illustrated in FIG. 19, the wiring 102 of the channel substrate 100 may be extended to the side face of the head 1, and the end of the wiring 102 may be electrically connected to the electrical connection pad 6, which is connected to an electrical component such as an external power supply, disposed outside the head 1. As illustrated in FIG. 19, the channel substrate 100 may not include the drive circuit 101.

As illustrated in FIG. 20, one end of each of the first lead 9a and the second lead 9b may be exposed to the outside of the head 1, and the exposed end may serve as the electrical connection pad 6. Also in this case, the channel substrate 100 may not include the drive circuit 101.

As illustrated in FIG. 21, one end of each of the first lead 9a and the second lead 9b may be extended to a side face of the head 1, and the electrical connection pad 6 may be electrically connected to the end of each of the first lead 9a and the second lead 9b. Also in this case, the channel substrate 100 may not include the drive circuit 101.

### Liquid Discharge Apparatus

A liquid discharge apparatus according to embodiments of the present disclosure is described below.

### Example of Line Printer

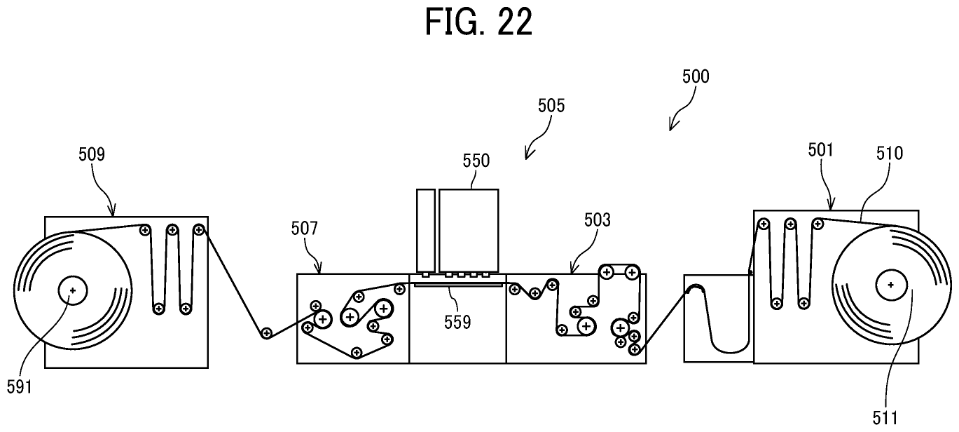

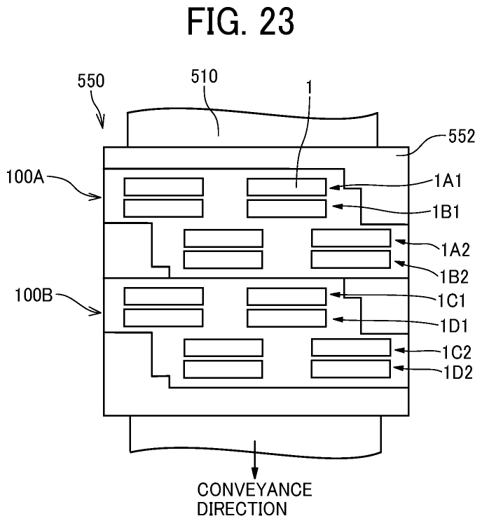

FIG. 22 is a schematic diagram of a printer 500 as the liquid discharge apparatus that discharges a liquid, according to an embodiment of the present disclosure, and FIG. 23 is a plan view of a head unit 550 of the printer 500 according to the present embodiment.

The printer 500 as an example of the liquid discharge apparatus includes a feeder 501 to feed a continuous medium 510, which is a continuous long recording medium, to a printing unit 505 and a guide conveyor 503 to guide and convey the continuous medium 510, fed from the feeder 501, to the printing unit 505. The printer 500 further includes the printing unit 505 to discharge a liquid onto the continuous medium 510 to form, for example, an image on the continuous medium 510, a dryer 507 to dry the continuous medium 510, and an ejector 509 to eject the dried continuous medium 510.

The continuous medium 510 is fed from a feed roller 511 of the feeder 501, guided and conveyed with rollers of the feeder 501, the guide conveyor 503, the dryer 507, and the ejector 509, and wound around a rewind roller 591 of the ejector 509. In the printing unit 505, the continuous medium 510 is conveyed on a conveyance guide 559 so as to face the head unit 550. The head unit 550 discharges a liquid onto the continuous medium 510 to form, for example, an image.

In the printer 500 according to the present embodiment, the head unit 550 includes a common base 552 on which two head modules 100A and 100B are mounted as illustrated in FIG. 23. In the present embodiment, in each of the head modules 100A and 100B, multiple liquid discharge heads 1 are arranged in a direction orthogonal to a conveyance direction of the continuous medium 510 to construct a line head (also referred to as a full-width head).

The head module 100A includes head arrays 1A1, 1B1, 1A2, and 1B2. Each of the head arrays 1A1, 1B1, 1A2, and 1B2 includes multiple liquid discharge heads 1 arranged in a head array direction perpendicular to the conveyance direction of the continuous medium 510. The head module 100B includes head arrays 1C1, 1D1, 1C2, and 1D2. Each of the head arrays 1C1, 1D1, 1C2, and 1D2 includes multiple liquid discharge heads 1 arranged in the head array direction. The head arrays 1A1 and 1A2 of the head module 100A discharge a liquid of the same color. Similarly, the head arrays 1B1 and 1B2 of the head module 100A are grouped as one set and discharge a liquid of the same desired color. The head arrays 1C1 and 1C2 of the head module 100B are grouped as one set and discharge a liquid of the same desired color.

The head arrays 1D1 and 1D2 of the head module 100B are grouped as one set and discharge a liquid of the same desired color. The liquid discharge head 1 described above is used in the head arrays 1A1 to 1D2.

### Example of Serial Printer

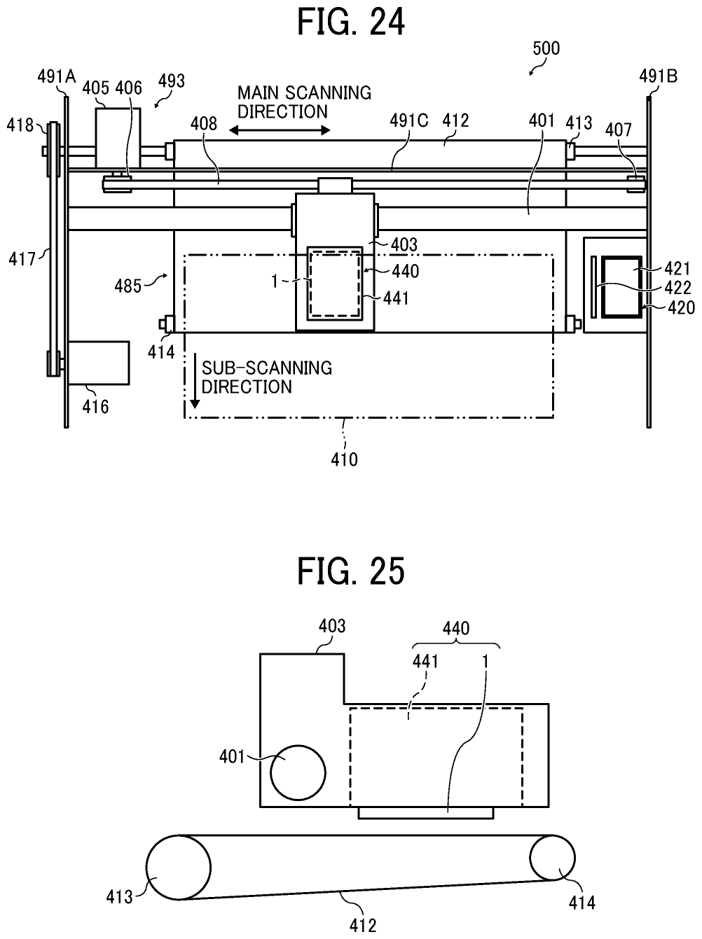

FIG. 24 is a plan view of another printer 500 as a liquid discharge apparatus according to embodiments of the present disclosure. FIG. 25 is a side view of the printer 500 in FIG. 24.

In the present embodiment, the printer 500 is a serial type apparatus, and a main-scanning moving mechanism 493 reciprocally moves a carriage 403 in a main scanning direction. The main-scanning moving mechanism 493 includes a guide 401, a main-scanning motor 405, and a timing belt 408. The guide 401 is bridged between left and right side plates 491A and 491B to moveably hold the carriage 403. The main-scanning motor 405 reciprocates the carriage 403 in the main scanning direction via the timing belt 408 looped around a drive pulley 406 and a driven pulley 407.

The carriage 403 mounts a liquid discharge unit 440 including the liquid discharge head 1 according to the above-described embodiments of the present disclosure and a head tank 441 as a single integrated unit. The liquid discharge head 1 discharges color liquids of, for example, yellow (Y), cyan (C), magenta (M), and black (K). The liquid discharge head 1 is mounted on the liquid discharge unit 440 such that a nozzle row including the multiple nozzles 2 is arranged in a sub-scanning direction perpendicular to the main scanning direction. The liquid discharge head 1 discharges the color liquid downward from the multiple nozzles 2. The liquid discharge head 1 is coupled to a supply mechanism including a liquid circulation device so that a liquid of a desired color is circulated and supplied.

The printer 500 includes a conveyance mechanism 485 to convey a sheet 410 as a recording medium. The conveyance mechanism 485 includes a conveyance belt 412 as a conveyor and a sub-scanning motor 416 to drive the conveyance belt 412. The conveyance belt 412 attracts the sheet 410 and conveys the sheet 410 to a position facing the liquid discharge head 1. The conveyance belt 412 is an endless belt and is stretched between a conveyance roller 413 and a tension roller 414. The sheet 410 can be attracted to the conveyance belt 412 by, for example, electrostatic attraction or air suction. The conveyance roller 413 is driven and rotated by the sub-scanning motor 416 via a timing belt 417 and a timing pulley 418, so that the conveyance belt 412 circulates in sub-scanning direction.

On one side of the carriage 403 in the main scanning direction, a maintenance mechanism 420 that maintains and recovers the liquid discharge head 1 is disposed lateral to the conveyance belt 412. The maintenance mechanism 420 includes, for example, a cap 421 to cap the nozzle face of the liquid discharge head 1 and a wiper 422 to wipe the nozzle face. The main-scanning moving mechanism 493, the maintenance mechanism 420, and the conveyance mechanism 485 are mounted onto a housing including the side plates 491A and 491B and a back plate 491C.

In the printer 500 having the above-described configuration, the sheet 410 is fed and attracted onto the conveyance belt 412 and conveyed in the sub-scanning direction by the circumferential movement of the conveyance belt 412. The liquid discharge head 1 is driven in response to an image signal while the carriage 403 moves in the main scanning direction to discharge a liquid onto the sheet 410 not in motion, thereby forming, for example, an image.

### Liquid Discharge Unit

The liquid discharge unit 440 according to the present embodiment is described below.

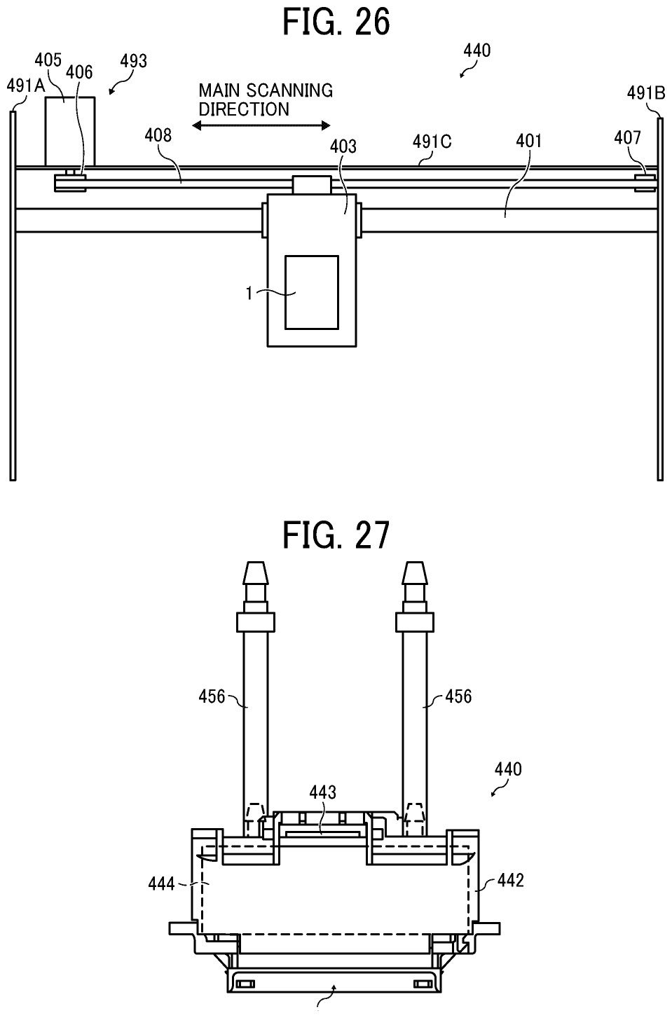

FIG. 26 is a plan view of a part of the liquid discharge unit 440 according to the present embodiment.

The liquid discharge unit 440 includes the housing, the main-scanning moving mechanism 493, the carriage 403, and the liquid discharge head 1 among components of the printer 500 as the liquid discharge apparatus illustrated in FIGS. 24 and 25. The side plates 491A and 491B, and the back plate 491C construct the housing.

In the liquid discharge unit 440, the maintenance mechanism 420 described above may be mounted on, for example, the side plate 491B.

FIG. 27 is a front view of another liquid discharge unit 440 according to the present embodiment.

The liquid discharge unit 440 includes the liquid discharge head 1 to which a channel component 444 is attached, and a tube 456 connected to the channel component 444. The channel component 444 is disposed inside a cover 442. In some embodiments, the liquid discharge unit 440 may include the head tank 441 instead of the channel component 444. A connector 443 for electrically connecting to the liquid discharge head 1 is provided on an upper portion of the channel component 444.

In the embodiments of the present disclosure, the term “liquid discharge apparatus” includes a liquid discharge head and drives the liquid discharge head to discharge liquid. The liquid discharge apparatus may be, for example, any apparatus that can discharge liquid to a material onto which liquid can adhere or any apparatus to discharge liquid toward gas or into liquid.

The “liquid discharge apparatus” may further include devices relating to feeding, conveying, and ejecting of the material onto which liquid can adhere and also include a pretreatment device and an aftertreatment device. The “liquid discharge apparatus” may be, for example, an image forming apparatus to form an image on a sheet by discharging ink, or a three-dimensional apparatus to discharge fabrication liquid to a powder layer in which powder material is formed in layers, so as to form a three-dimensional object.

The “liquid discharge apparatus” is not limited to an apparatus that discharges liquid to visualize meaningful images such as letters or figures. For example, the liquid discharge apparatus may be an apparatus that forms meaningless images such as meaningless patterns or an apparatus that fabricates three-dimensional images.

The above-described term “material onto which liquid can adhere” represents a material on which liquid is at least temporarily adhered, a material on which liquid is adhered and fixed, or a material into which liquid is adhered to permeate. Specific examples of the “material onto which liquid can adhere” include, but are not limited to, a recording medium such as a paper sheet, recording paper, a recording sheet of paper, a film, or cloth, an electronic component such as an electronic substrate or a piezoelectric element, and a medium such as layered powder, an organ model, or a testing cell. The “material onto which liquid can adhere”includes any material to which liquid adheres, unless particularly limited.

Examples of the “material onto which liquid can adhere” include any materials to which liquid can adhere even temporarily, such as paper, thread, fiber, fabric, leather, metal, plastic, glass, wood, ceramic, a current collector such as an aluminum foil or a copper foil, and an electrode in which an active material layer is formed on the current collector.

Further, the term “liquid” is not limited to a particular liquid and includes any liquid having a viscosity or a surface tension that can be discharged from the head. However, preferably, the viscosity of the liquid is not greater than 30 mPa. s under ordinary temperature and ordinary pressure or by heating or cooling. Examples of the liquid include a solution, a suspension, or an emulsion that contains, for example, a solvent, such as water or an organic solvent; a colorant, such as dye or pigment; a functional material, such as a polymerizable compound, a resin, or a surfactant; a biocompatible material, such as DNA, amino acid, protein, or calcium; an edible material, such as a natural colorant; an active material and a solid electrolyte used as an electrode material; or ink containing a conductive material or an insulating material. Such a solution, a suspension, or an emulsion can be used for, e.g., inkjet ink, surface treatment solution, a liquid for forming components of electronic element or light-emitting element or a resist pattern of electronic circuit, a material solution for three-dimensional fabrication, an electrode, or an electrochemical element.

The liquid discharge apparatus may be an apparatus to relatively move the liquid discharge head and the material onto which liquid can adhere. However, the liquid discharge apparatus is not limited to such an apparatus. For example, the liquid discharge apparatus may be a serial head apparatus that moves the liquid discharge head or a line head apparatus that does not move the liquid discharge head.

Examples of the “liquid discharge apparatus” further include: a treatment liquid applying apparatus that discharges a treatment liquid onto a sheet to apply the treatment liquid to the surface of the sheet to reform the surface of the sheet; and an injection granulation apparatus that injects a composition liquid, in which a raw material is dispersed in a solution, through a nozzle to granulate fine particle of the raw material.

The “liquid discharge apparatus” is not limited to a stationary apparatus. The liquid discharge apparatus may be, for example, a robot which is equipped with a liquid discharge head and movable by remote control or autonomous driving. The movable robot can paint an outer wall of a building and paint a road marking (e.g., a crosswalk, a stop line, and a speed limit) on a road. In this case, a building and a road are also included in the “material onto which liquid can adhere.”

The above-described embodiments of the present disclosure are examples, and the following aspects of the present disclosure can provide, for example, advantageous effects described below.

### Aspect 1

According to Aspect 1, a liquid discharge head (e.g., the head 1) includes a common liquid chamber (e.g., the common liquid chamber 3) to store a liquid, multiple nozzles (e.g., the nozzles 2) communicating with the common liquid chamber, vibration generators (e.g., the piezoelectric elements 5) to individually vibrate the multiple nozzles, and a flexible member (e.g., the elastic film 122 or 123) in the common liquid chamber to reduce vibrations of the liquid. The common liquid chamber includes liquid chambers (e.g., the liquid chambers 4) corresponding to the multiple nozzles, and the flexible member is disposed at a position facing the multiple nozzles of the liquid chambers.

In other words, a liquid discharge head includes a common liquid chamber having multiple liquid chambers communicating with each other through the common liquid chamber, a vibration film having multiple nozzles, multiple vibration generators, and a flexible member. The common liquid chamber stores a liquid. The multiple nozzles respectively communicate with the multiple liquid chambers. The multiple vibration generators individually vibrate the vibration film around the multiple nozzles, respectively. The flexible member is opposed to the multiple nozzles in the common liquid chamber. The flexible member is deformable by the liquid in the common liquid chamber vibrated by the vibration film.

### Aspect 2

According to Aspect 2, in Aspect 1, the flexible member (e.g., the elastic film 122 or 123) in the common liquid chamber (e.g., the common liquid chamber 3) has a first face (e.g., the first face 122-1 or 123-1) opposed to the multiple nozzles (e.g., the nozzles 2) and a second face (e.g., the second face 122-2 or 123-2) opposite the first face. At least the first face is in contact with the liquid in the common liquid chamber.

### Aspect 3

According to Aspect 3, in Aspect 2, the first face (e.g., the first face 122-1 or 123-1) and the second face (e.g., the second face 122-2 or 123-2) of the flexible member (e.g., the elastic film 122 or 123) are in contact with the liquid in the common liquid chamber (e.g., the common liquid chamber 3).

### Aspect 4

According to Aspect 4, in Aspect 2, the first face (e.g., the first face 122-1 or 123-1) of the flexible member (e.g., the elastic film 122 or 123) is in contact with the liquid in the common liquid chamber (e.g., the common liquid chamber 3), and the second face (e.g., the second face 122-2 or 123-2) of the flexible member is in contact with a gas in the common liquid chamber.

### Aspect 5

According to Aspect 5, in any one of Aspects 1 to 4, the flexible member (e.g., the elastic film 122 or 123) includes a resin film.

### Aspect 6

According to Aspect 6, in any one of Aspects 1 to 4, the flexible member (e.g., the elastic film 122 or 123) includes a metal film.

### Aspect 7

According to Aspect 7, in any one of Aspects 2 to 6, the flexible member (e.g., the elastic film 123) has multiple openings (e.g., the openings 123b) penetrating the first face (e.g., the first face 123-1) and the second face (e.g., the second face 123-2).

In other words, the flexible member has multiple openings each penetrating through the flexible member.

### Aspect 8

According to Aspect 8, in any one of Aspects 2 to 7, the flexible member (e.g., the elastic film 122 or 123) has an air layer (e.g., the hollow portion 122a or 123a filled with air) between the first face (e.g., the first face 122-1 or 123-1) and the second face (e.g., the second face 122-2 or 123-2).

### Aspect 9

According to Aspect 9, in any one of Aspects 2 to 8, the liquid discharge head (e.g., the head 1) further includes a partition (e.g., the internal wall 4a of the liquid chambers 4) on the side facing the first face (e.g., the first face 122-1 or 123-1) of the flexible member (e.g., the elastic film 122 or 123) to partition adjacent nozzles of the multiple nozzles. When an end of the partition close to the first face of the flexible member is defined as a first end (e.g., the first end 4a-1), a distance (e.g., the distance L1 or L2) between the first face of the flexible member and the first end of the partition is in the range of 10 to 600 μm.

In other words, the liquid discharge head further includes a partition partitioning adjacent multiple liquid chambers. The partition has a first end facing the first face of the flexible member and a second end connected to the vibration film. A distance between the first face of the flexible member and the first end of the partition is in a range of 10 to 600 μm.

### Aspect 10

According to Aspect 10, in any one of Aspects 2 to 8, the liquid discharge head (e.g., the head 1) further includes a partition (e.g., the internal wall 4a of the liquid chambers 4) on the side facing the first face (e.g., the first face 122-1 or 123-1) of the flexible member (e.g., the elastic film 122 or 123) to partition adjacent nozzles of the multiple nozzles. When an end of the partition close to the first face of the flexible member is defined as a first end (e.g., the first end 4a-1), the first face of the flexible member is in contact with the first end of the partition. In other words, the liquid discharge head further includes a partition partitioning adjacent multiple liquid chambers. The partition has a first end facing the first face of the flexible member and a second end connected to the vibration film. The first face of the flexible member is in contact with the first end of the partition.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

This patent application is based on and claims priority to Japanese Patent Application No. 2022-170924, filed on Oct. 25, 2022, in the Japan Patent Office, the entire disclosure of which is hereby incorporated by reference herein.

### REFERENCE SIGNS LIST

1 Liquid discharge head
2 Nozzle
3 Common liquid chamber
4 Liquid chamber
4a Inner wall (an example of a partition)
5 Piezoelectric element (an example of a vibration generator)
120 Frame
121 Liquid supply port
122, 123 Elastic film (an example of a flexible member)

1. A liquid discharge head comprising:
a common liquid chamber to store a liquid, the common liquid chamber having multiple liquid chambers communicating with each other through the common liquid chamber;
a vibration film having multiple nozzles respectively communicating with the multiple liquid chambers;
multiple vibration generators to individually vibrate the vibration film around the multiple nozzles, respectively; and
a flexible structure opposed to the multiple nozzles in the common liquid chamber, the flexible structure being deformable by the liquid in the common liquid chamber vibrated by the vibration film.

2. The liquid discharge head according to claim 1, wherein:
the flexible structure in the common liquid chamber includes:
a first face opposed to the multiple nozzles; and
a second face opposite the first face, and
the first face is in contact with the liquid in the common liquid chamber.

3. The liquid discharge head according to claim 2, wherein:
the second face of the flexible structure flexible structure is in contact with the liquid in the common liquid chamber.

4. The liquid discharge head according to claim 2, wherein:
the second face of the flexible structure is in contact with a gas in the common liquid chamber.

5. The liquid discharge head according to claim 1, wherein:
the flexible structure includes a resin film.

6. The liquid discharge head according to claim 1, wherein:
the flexible structure includes a metal film.

7. The liquid discharge head according to claim 2, wherein:
the flexible structure includes multiple openings each penetrating through the flexible structure.

8. The liquid discharge head according to claim 2, wherein:
the flexible structure includes an air layer between the first face and the second face.

9. The liquid discharge head according to claim 8, further comprising:
a partition partitioning adjacent multiple liquid chambers,
wherein:
the partition includes a first end facing the first face of the flexible structure and a second end connected to the vibration film, and
a distance between the first face of the flexible structure and the first end of the partition is in a range of 10 to 600 μm.

10. The liquid discharge head according to claim 8, further comprising:
a partition partitioning adjacent multiple liquid chambers,
wherein:
the partition includes a first end facing the first face of the flexible structure and a second end connected to the vibration film, and
the first face of the flexible structure is in contact with the first end of the partition.

11. A liquid discharge apparatus comprising:
the liquid discharge head according to claim 1, to discharge the liquid to a recording medium; and
a conveyor to convey the recording medium to a position facing the liquid discharge head.
